(19) United States
(12) Patent Application Publication
(10) Pub. No.: US 2016/0100397 A1
(43) Pub. Date: Apr. 7, 2016

(54) UPLINK SCHEDULING INFORMATION REPORTING APPARATUS AND SYSTEM SUPPORTING MULTI-CONNECTIVITY

(71) Applicant: ALCATEL LUCENT, Paris (FR)

(72) Inventors: Pingping Wen, Shanghai (CN); Yun Deng, Shanghai (CN); Chandrika Worrall, Newbury (GB); Tao Yang, Shanghai (CN)

(73) Assignee: Alcatel Lucent, Boulogne Billancourt (FR)

(21) Appl. No.: 14/890,312

(22) PCT Filed: Apr. 29, 2014
(86) PCT No.: PCT/IB2014/000960

§ 371 Date: Nov. 10, 2015

(30) Foreign Application Priority Data
May 10, 2013 (CN) 2013 10173404.6

(51) Int. Cl. H04W 72/04; H04W 76/02; H04W 24/10

(52) U.S. Cl. CPC H04W 72/0413; H04W 24/10; H04W 76/026

(57) ABSTRACT

One objective of the present invention is to provide uplink scheduling information reporting apparatus and System supporting multi-connectivity. Herein, a UE connected to multiple eNBs, the UE receives trigger configuration information about buffer status report of a logical channel group that a corresponding radio bearer belongs to, and radio bearer configuration information and uplink resource configuration information respectively corresponding to each of the multiple eNBs, when the BSR trigger condition of at least one of the multiple eNBs is satisfied, transmit to a corresponding eNB the buffer status report of the logical channel group that its corresponding radio bearer belongs to, so as to support uplink scheduling report in multi-connectivity. The reporting mechanism provides the serving eNB with information about data amount that can be transmitted in UL buffer of a UE, so as to support multi-connectivity, and enables macro cell to provide a better coverage of the control plane data and enables small cell to provide larger capacity.

### TECHNICAL FIELD

The present invention relates to the field of wireless communication technology, and more specifically, to an uplink scheduling information reporting technology supporting multi-connectivity.

### BACKGROUND OF THE INVENTION

Due to capacity improvement and solving the coverage of blind points brought by low power nodes such as micro cells, pico cells, and femto cells, there are big interests on small cell deployments and enhancements. In 3GPP R12, one new Study Item “Small Cell Enhancements for E-UTRA and E-UTRAN—Higher-layer aspects” has been approved and one important point is to support the multi-connectivity (including dual connectivity) to macro and small cells. Furthermore scheduling is one critical function to allocate the resource to the user to achieve the desired QoS and system capacity. Scheduling information reporting including buffer status report (BSR) and Scheduling request (SR) is one important input factor for the Uplink (UL) scheduler to know how much data need to be transmitted for each Logic Channel Group (LCG). In current system, there is only serving node for the user, therefore the user only need to report the BSR and SR to one base station. To support multi-connectivity, the user needs to have two or more serving cells and a distributed scheduler at each of the serving cells if these cells are linked with non-ideal backhaul, therefore what values should be reported to which cell and How the value is reported to each cell should be determined.

The BSR procedure is used to provide the serving eNB with information about the amount of data available for transmission in the UL buffers of the user equipment (UE). The SR is used for requesting UL-SCH resources for new transmission. When there is no resource allocation to transmit the BSR, SR sending will be triggered. In current system, since there is only one serving node, although there are multiple serving cells in the Carrier Aggregation (CA) case which are, however, physically co-located, the BSR and SR sending procedure is relatively simple, e.g.:
There is only one node to get BSR and SR for scheduling;
The BSR procedure has only one set of trigger;
The UE shall transmit at most one Regular/Periodic BSR in a TTI (Transmission Time Interval);
If the UE is requested to transmit multiple MAC PDUs in a TTI, it may include a padding BSR in any of the MAC PDUs which do not contain a Regular/Periodic BSR.

Based on the above analysis, the existing mechanism of buffer status report and scheduling request cannot support multi-connectivity (including dual connectivity). Moreover, in the case of multi-connectivity (including dual-connectivity), due to the existence of two or more serving sells, if these serving cells are linked with non-ideal backhaul connection, then an independent distributed scheduler is further needed at each eNB. If more (two) cells support control plane and data plane splitting, i.e., the SRB (Signaling Radio Bearer) and DRB (Data Radio Bearer) splitting is supported between these more (two) cells, a user needs to report the BSR and SR to the more (two) cells, respectively. Therefore, in the case of multi-connectivity (including dual connectivity), what value to be reported and How to report when the user is transmitted to more than one cell simultaneously, especially with DRB splitting case should be solved.

### SUMMARY OF THE INVENTION

One objective of the present invention is to provide uplink scheduling information reporting apparatus and system supporting multi-connectivity (including dual connectivity).

According to one aspect of the present invention, an uplink scheduling information reporting apparatus supporting multi-connectivity at a UE is provided, wherein the UE is connected to multiple eNBs, the apparatus comprising:

a configuration receiving module configured to receive trigger configuration information about buffer status report of a logical channel group that a corresponding radio bearer belongs to, and radio bearer configuration information and uplink resource configuration information respectively corresponding to each of the multiple eNBs, wherein the trigger configuration information is available for the UE to configure BSR trigger condition corresponding to each of the multiple eNBs;

a BSR report module configured to, when the BSR trigger condition of at least one of the multiple eNBs is satisfied, transmit to a corresponding eNB the buffer status report of the logical channel group that its corresponding radio bearer belongs to.

According to another aspect of the present invention, a facilitating uplink scheduling information reporting apparatus supporting multi-connectivity at a macro eNB is further provided, wherein a UE is connected to the macro eNB and multiple other eNBs, the apparatus comprising:

a first configuration sending module configured to transmit, to the UE, trigger configuration information about buffer status report of a logical channel group to which a data radio bearer corresponding to the macro eNB belongs, for the UE to configure a BSR trigger condition corresponding to the macro eNB;

a first BSR receiving module configured to receive, from the UE, the buffer status report when the BSR trigger condition is satisfied;

a first transmission determining module configured to determine amount of data transmitted by the macro eNB for the data radio bearer based on the buffer status report.

According to a further aspect of the present invention, a facilitating uplink scheduling information reporting apparatus supporting multi-connectivity at a small cell eNB is further provided, wherein a UE is connected to the small cell eNB and multiple other eNBs, the apparatus comprising:

a second configuration sending module configured to transmit, to the UE, trigger configuration information about buffer status report of a logical channel group to which a data radio bearer corresponding to the small cell eNB belongs, for the UE to configure a BSR trigger condition corresponding to the small cell eNB;

a second BSR receiving module configured to receive, from the UE, the buffer status report when the BSR trigger condition is satisfied;

a second transmission determining module configured to determine amount of data transmitted by the small cell eNB for the data radio bearer based on the buffer status report and historical scheduling information of the small cell.

According to a still further aspect of the present invention, A facilitating uplink scheduling information reporting apparatus supporting multi-connectivity at a small cell eNB is further provided, wherein a UE is connected to one or more small cell eNBs and one macro eNB, the small cell corresponding to the small cell eNB is located within a macro cell provided by the macro eNB, the apparatus comprising:

a third configuration sending module configured to transmit, to the UE, trigger configuration information about buffer status report of a logical channel group to which a data radio bearer corresponding to the small cell eNB belongs, for the UE to configure a BSR trigger condition corresponding to the small cell eNB;

a third BSR receiving module configured to receive, from the UE, the buffer status report when the BSR trigger condition is satisfied;

a third transmission receiving module configured to receive, from the macro eNB, decision information about amount of data transmitted by the small cell eNB for the data radio bearer as determined by the macro eNB for the small cell eNB.

According to a yet further aspect of the present invention, a facilitating uplink scheduling information reporting apparatus supporting multi-connectivity at a small cell eNB is further provided, wherein a UE is connected to one or more small cell eNBs and one macro eNB, the small cell corresponding to the small cell eNB is located within a macro cell provided by the macro eNB, the apparatus comprising:

a fourth BSR receiving module configured to receive, from the macro eNB, the buffer status report, transmitted by the UE and forwarded by the macro eNB, of the logical channel group to which a data radio bearer corresponding to the small cell eNB belongs, and decision information about the amount of data transmitted by the small cell eNB for the data radio bearer as determined by the macro eNB for the small cell eNB.

According to one aspect of the present invention, an uplink scheduling information reporting system supporting multi-connectivity is further provided, wherein the system comprises the aforementioned uplink scheduling information reporting apparatus supporting multi-connectivity at a UE according to the one aspect of the present invention, the aforementioned facilitating uplink scheduling information reporting apparatus supporting multi-connectivity at a macro eNB according to the another aspect of the present invention, and one of the aforementioned facilitating uplink scheduling information reporting apparatuses supporting multi-connectivity at a small cell base station according to the further, the still further, and the yet further aspect of the present invention.

Compared with the prior art, the present invention provides an uplink scheduling information reporting mechanism supporting multi-connectivity (including dual-connectivity), wherein the scheduling information reporting includes buffer status report and scheduling request. Herein the reporting mechanism provides the serving eNB with information about data amount that can be transmitted in UL buffer of a UE, which may be applicable in cases of DRB splitting and DRB non-splitting, so as to support multi-connectivity (including dual-connectivity). Further, the macro cells and small cells in multi-connectivity (including dual-connectivity) to the UE are linked with non-ideal backhaul connection, and thus a distributed scheduler for the multiple cells is needed. Therefore, multi-connectivity (including dual-connectivity) enables macro cell to provide a better coverage of the control plane data and enables small cell to provide larger capacity.

### BRIEF DESCRIPTION OF FIGURES

Through reading the following detailed depiction on the non-limiting embodiments with reference to the accompanying drawings, the other features, objectives, and advantages of the present invention will become clearer.

FIG. 1 shows a flowchart of a method for implementing uplink scheduling information reporting with cooperation between a UE 10, and a macro eNB 20 and a pico eNB 30 in dual-connectivity with the UE 10 according to one embodiment of the present invention;

FIG. 2 shows a schematic diagram of an application scenario according to one preferred embodiment of the present invention;

FIG. 3 shows a schematic diagram of an application scenario according to another preferred embodiment of the present invention;

FIG. 4 shows a schematic diagram of an application scenario according to a further preferred embodiment of the present invention;

FIG. 5 shows a schematic diagram of an apparatus at a UE 10 that is in dual-connectivity with a macro eNB 20 and a pico eNB 30 to cooperatively implement uplink scheduling information reporting according to another embodiment of the present invention.

Same or like reference numerals in the accompanying drawings indicate the same or corresponding components.

### EMBODIMENTS OF THE INVENTION

Hereinafter, the present invention will be further described in detail with reference to the accompanying drawings.

In the present invention, multi-connectivity means a UE is connected simultaneously to multiple eNBs which may all be macro eNBs, all be small cell eNBs, or a combination of both. For example, a UE is connected simultaneously to two macro eNBs, or the UE is connected simultaneously to a macro eNB and a small cell eNB. Further, there might not be an affiliation relationship between the small cell eNB and the macro eNB simultaneously connected to the UE. For example, the UE is connected simultaneously to a macro eNB and a small cell eNB, while the small cell corresponding to the small cell eNB is located within a macro cell provided by another macro eNB.

In the case of multi-connectivity, respective eNBs connected to the UE may transmit, to the UE, trigger configuration information about the buffer status report of the logical channel group to which a corresponding radio bearer belongs, radio bearer configuration information, and uplink resource configuration information, etc., respectively. Preferably, when the UE is connected to a macro eNB and a plurality of small cell eNBs belonged to the macro eNB, the macro eNB may determine, for the respective aforementioned small cell eNBs, their respective trigger configuration information about the buffer status report of the logical channel group to which the corresponding radio bearer belongs, and transmit the configuration information to the UE.

For the convenience of illustration, dual connectivity is mostly taken for example and maken illustration in this description, and those skilled in the art should understand that, such example(s) is only for the purpose of illustration of the present invention and should not be construed as any limitation to the present invention, and the multi-connectivity other than dual-connectivity is also applicable to the present invention and included in the protection scope of the present invention.

In the case of dual connectivity, a UE may be connected simultaneously to two base stations, e.g., an eNB corresponding to a macro cell (hereinafter referred to “macro eNB”) and an eNB corresponding to a small cell within the macro cell, wherein the small cell can be a micro cell, a pico cell, a femto cell, etc. For the convenience of illustration, this description mostly takes a pico cell within the macro cell as an example, such that the dual-connectivity UE is further connected to the eNB corresponding to the pico cell (hereinafter referred to as “pico eNB”).

Note that the above pico cell is only exemplary and should not be construed as any limitation to the present invention; other existing or future small cells, if applicable to the present invention, should be covered with the patent protection scope of the present invention.

Herein, for the case of DRB non-splitting transmission in two base stations, i.e., one DRB can only be transmitted in one base station thereof, the UE reports, to a corresponding base station, buffer status report of the LCG to which the DRB is mapped; for the case of DRB splitting transmission in two base stations, i.e., one DRB is transmitted by two base stations, both the macro eNB and the pico eNB need to obtain the buffer status report of the LCG to which the DRB is mapped, and transmit partial amount of data for the DRB, respectively.

However, the situation is different for control plane data. Since the small cell may have partial RRC function for local resource allocation, the SRB may be sent to macro cell and small cell, i.e., SRB splitting needs to be supported. Besides, under this situation, UE needs to differentiate which cell the SRB will be sent to and the buffer data amount of the SRB transmitted to the corresponding cell, and report the corresponding cell the buffer status report of the LCG to which the SRB belongs. In other words, the UE only reports the buffer status report of the LCG to the eNB which the logic channel or the radio bearer is allowed to transmit to.

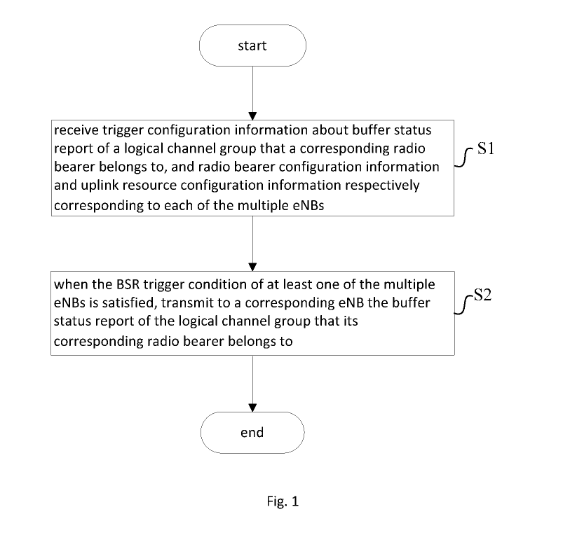

FIG. 1 is a flowchart of a method according to one embodiment of the present invention, which shows that a UE 10 cooperates with a macro eNB 20 and a pico eNB 30 in dual-connectivity therewith to implement the uplink scheduling information reporting.

Specifically, in step 51, the macro eNB 20 and the pico eNB 30 transmit, to the UE 10, trigger configuration information about buffer status report of the logical channel group to which their respective corresponding radio bearer belongs, radio bearer configuration information, and uplink resource configuration information, respectively; correspondingly, the UE 10 receives, from the macro eNB 20 and the pico eNB 30, their respective configuration information mentioned above. Here, the trigger configuration information includes BSR trigger configuration information corresponding to the macro eNB 20 and the pico eNB 30, respectively, for the UE to configure the corresponding BSR configuration conditions for the respective eNBs, e.g., the configuration information of the BSR trigger timers corresponding to the respective eNBs; the radio bearer configuration information includes radio bearer types that can be transmitted by respective eNBs; the uplink resource configuration information includes configuration information of uplink resources allocated by respective eNBs for the UE, e.g., PUCCH resource configuration information. Thus, for a UE supporting dual-connectivity, it needs to perform Individual MAC-MainConfig for the connected two cells.

In step S2, when a BSR trigger condition of at least one of the multiple eNBs to which the UE 10 is connected is satisfied, the UE 10 transmits, to the corresponding eNB, the buffer status report of the logical channel group to which its corresponding radio bearer belongs. For example, for the SRB buffer status report, the UE 10 needs to maintain a set of trigger procedure for the macro eNB 20 and the pico eNB 30, respectively, e.g., the periodic BSR-Timer and retxBSR-Timer. When the BSR trigger condition of a corresponding eNB is satisfied, e.g., the corresponding timer expires, the UE 10 reports, to the corresponding eNB, the BSR of the LCG that the corresponding SRB belongs to.

Here, report of the periodic BSR and regular BSR may conform to the existing rules. However, for a padding BSR report, if the UE 10 is requested to transmit multiple MAC PDUs to one eNB (e.g., the macro eNB 20 or the pico eNB 30) in a TTI, it may be included in any of the MAC PDUs which do not contain a Regular/Periodic BSR.

Further, in step S2, when a BSR trigger condition of at least one of the multiple eNBs to which the UE 10 is connected is satisfied and the corresponding eNB does not currently allocate uplink resource to the UE yet, the UE 10 transmits a scheduling request to the eNB to obtain the uplink resource for reporting the buffer status report to the eNB. That is, if there is no uplink resource currently allocated to transmit BSR, SR sending will be triggered. Likewise, there are also two sets of SR sending procedure for the two eNBs separately. Specifically, when a BSR trigger condition of the macro eNB 20 is satisfied, if there is no valid PUCCH resource configured by the macro eNB 20 for the SR within any TTI, the UE 10 initiates random access to the macro eNB 20. When a BSR trigger condition of a small cell eNB is satisfied, if there is no valid PUCCH resource configured by the small cell eNB for the SR within any TTI, the UE 10 initiates random access to the small cell eNB. Therefore, both eNBs should support PUCCH and random access.

For the case of DRB splitting, since one DRB can be transmitted by multiple eNBs, while the multiple eNBs are linked with non-ideal backhaul connection, each eNB needs an independent distributed scheduler. Therefore, its implementation is more complex and has many variations.

Here, the multiple eNBs transmitting the DRB may be all or a part of the eNBs connected to the UE, and such eNBs are called transmitting eNBs, wherein each transmitting eNB may obtain the total BSR report of the DRB and determine itself the amount of data it can transmit. Further, when one of the transmitting eNB is a macro eNB, and the other transmitting eNBs are small cell eNBs belonged to the macro eNB, the macro eNB may determine, for the other transmitting eNBs, the amount of data that can be transmitted by respective the other transmitting eNBs for the RDB.

Hereinafter, some preferred embodiments will be illustrated with reference to the accompanying drawings, and the example will be taken with one DRB to be transmitted on two base stations, which two transmitting base stations are a macro eNB 20 and a pico eNB 30.

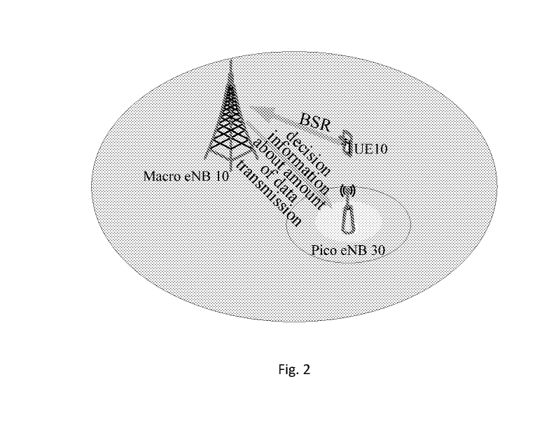

In one preferred embodiment of the present invention, with cooperative reference to FIG. 1 and FIG. 2, in step 51, the macro eNB 20 transmits, to the UE 10, trigger configuration information about the buffer status report of the logical channel group to which the data radio bearer corresponding to the macro eNB 20 belongs, for the UE 10 to configure its BSR trigger condition corresponding to the macro eNB 20; in step S2, when the BSR trigger condition of the macro eNB 20 is satisfied, the UE 10 transmits the buffer status report of the logical channel group to which the DRB belongs to the macro eNB 20 through MAC PDU. Here, based on the existing rules, the BSR may be triggered as periodic BSR, regular BSR, or padding BSR.

Afterwards, the macro eNB 20 uses its flow control function to determine the amount of data transmitted respectively by itself and the pico eNB 30 for the DRB, based on respective load and channel condition of itself and the pico eNB 30 etc in accordance with the buffer status report, and then provides the BSR and the decision information corresponding to the amount of data determined to be transmitted by the pico eNB 30 to the pico eNB 30 via the X2 interface. Preferably, the decision information may be included in the BSR. Here, the decision information includes that the amount of data transmitted by the pico eNB 30 or that the ratio of the amount of data transmitted by the pico eNB 30 over the buffer data amount in the DRB determined by the macro eNB 20. Correspondingly, the pico eNB 30 receives, from the macro eNB 20, the buffer status report forwarded by the macro eNB 20 and the decision information about the amount of data determined by the macro eNB 20 to be transmitted by the pico eNB 30 for the DRB, such that the pico eNB 30 allocates uplink resource to the UE 10.

In addition, due to there is delay from the UE sending the BSR to the macro eNB 20, in this duration, the UE is possible to be allocated resources and transmit data, therefore the macro eNB 20 may deduce the data transmission amount during this period and correspondingly reduce this part of amount of data from the buffer status report. Moreover, due to the uncertain latency of X2 interface, when the macro eNB 20 forwards the BSR transmitted by the UE to the pico eNB 30, the BSR sending time may also be provided along to the pico eNB30, wherein the BSR sending time may be the time when the UE reports the BSR, or the time when the macro eNB 20 forwards the BSR, which may be labeled as SFN+subframe number, for example. Correspondingly, the pico eNB 30 may also receive the BSR sending time from the macro eNB 20 to deduce the amount of data that has been transmitted by the UE 10, and allocate uplink resource to the UE based thereupon.

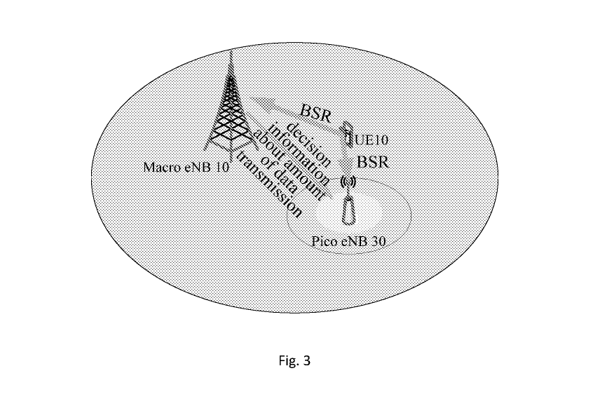

In another preferred embodiment of the present invention, with cooperative reference to FIG. 1 and FIG. 3, in step 1, the macro eNB 20 and the pico eNB 30 transmit, to the UE 10, trigger configuration information about buffer status report of the logical channel group to which the data radio bearer respectively corresponding to the macro eNB 20 and the pico eNB 30 belongs, respectively, for the UE 10 to configure the BSR trigger conditions corresponding to the macro eNB 20 and the pico eNB 30, respectively; in step S2, when the BSR trigger conditions of the macro eNB 20 and the pico eNB 30 are satisfied, the UE transmits the buffer status report of the logical channel group to which the DRB belongs to the macro eNB 20 and the pico eNB 30, respectively, so as to avoid untimely transmission of the X2 interface having a non-ideal backhaul link.

Afterwards, the macro eNB 20 uses its flow control function to determine the amount of data transmitted respectively by itself and the pico eNB 30, and further provides the decision information corresponding to the amount of data to the pico eNB 30 via the X2 interface. Here, the decision information includes the amount of data determined by the macro eNB 20 to be transmitted by the pico eNB 30 or the ratio that the amount of data transmitted by the pico eNB 30 over the buffer data amount of the DRB, which may be used to facilitate the pico eNB 30 to avoid over resource allocation for the UE 10. Further, considering the latency of the X2 interface, the decision information may be provided, along with its sending time, to the pico eNB 30, so as to avoid over resource allocation on the pico eNB for the UE 10.

Besides, since the uplink resource allocation is completely different in two eNBs, for the same BSR report, it is possible that the macro eNB 20 has uplink resource allocation to transmit the BSR, while the pico eNB 30 has no uplink resource allocation to transmit the BSR, so it is necessary to trigger a SR procedure to request the pico eNB 30 for corresponding uplink resource. Therefore, the UE 10 needs to maintain two sets of BSR trigger and SR trigger mechanisms for the two eNBs separately.

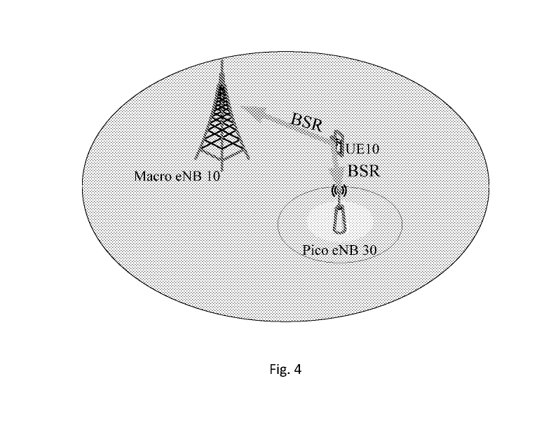

In another preferred embodiment of the present invention, with cooperative reference to FIG. 1 and FIG. 4, in step 51, the macro eNB 20 and the pico eNB 30 transmit, to the UE 10, trigger configuration information about buffer status report of the logical channel group to which the data radio bearer respectively corresponding to the macro eNB 20 and the pico eNB 30 belongs, respectively, for the UE 10 to configure the BSR trigger conditions corresponding to the macro eNB 20 and the pico eNB 30, respectively; in step S2, when the BSR trigger conditions of the macro eNB 20 and the pico eNB 30 are satisfied, the UE transmit the buffer status report of the logical channel group to which the DRB belongs to the macro eNB 20 and the pico eNB 30, respectively.

Afterwards, the macro eNB 20 and the pico eNB 30 determine, based on their respective historical scheduling information, their respective amount of data transmission; therefore, it is unnecessary to exchange information between the macro eNB 20 and the pico eNB 30. Here, the historical scheduling information includes historical scheduling result of the macro eNB 20 or the pico eNB 30 in their respective single-connectivity and/or multi-connectivity, e.g., the last transmitted data amount autonomously determined by the pico eNB 30 in the case of dual-connectivity with DRB splitting, or the last transmitted data amount determined by the macro eNB 20 for the pico eNB 30 in the case of dual-connectivity with DRB splitting.

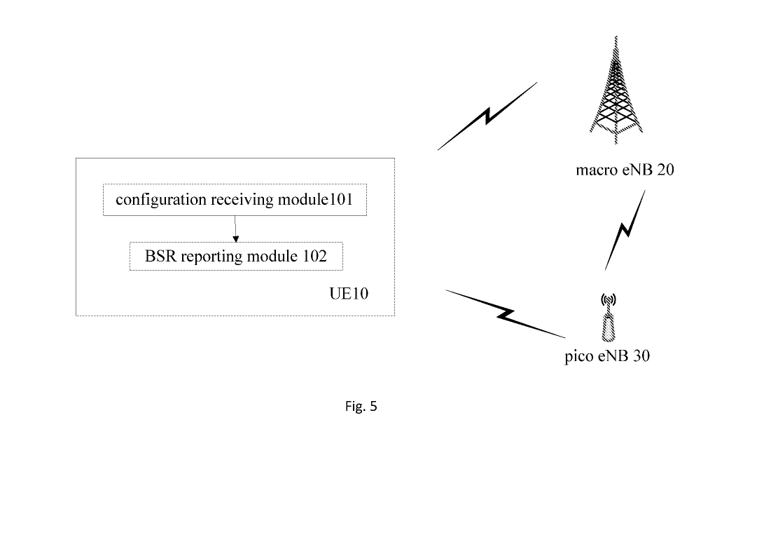

FIG. 5 is an apparatus diagram according to one embodiment of the present invention, which illustrates various modules of the UE 10 for cooperative implementation of uplink scheduling information reporting in dual-connectivity with a macro eNB 20 and a pico eNB 30. As shown in FIG. 5, the UE 10 includes a configuration module 101 and a BSR reporting module 102.

Specifically, the macro eNB 20 and the pico eNB 30 transmit, to the UE 10, trigger configuration information about buffer status report of the logical channel group to which their respective corresponding radio bearer belongs, radio bearer configuration information, and uplink resource configuration information, respectively; correspondingly, the configuration module 101 of the UE 10 receives, from the macro eNB 20 and the pico eNB 30, their respective configuration information mentioned above. Here, the trigger configuration information includes BSR trigger configuration information corresponding to the macro eNB 20 and the pico eNB 30, respectively, for the UE to configure the corresponding BSR configuration conditions for the respective eNBs, e.g., the configuration information of the BSR trigger timers corresponding to the respective eNBs; the radio bearer configuration information includes radio bearer types that can be transmitted by respective eNBs; the uplink resource configuration information includes configuration information of uplink resources allocated by respective eNBs for the UE, e.g., PUCCH resource configuration information. Thus, for a UE supporting dual-connectivity, it needs to perform Individual MAC-MainConfig for the connected two cells.

when a BSR trigger condition of at least one of the multiple eNBs to which the UE 10 is connected is satisfied, the BSR reporting module 102 of the UE 10 transmits, to the corresponding eNB, the buffer status report of the logical channel group to which its corresponding radio bearer belongs. For example, for the SRB buffer status report, the UE 10 needs to maintain a set of trigger procedure for the macro eNB 20 and the pico eNB 30, respectively, e.g., the periodic BSR-Timer and retxBSR-Timer. When the BSR trigger condition of a corresponding eNB is satisfied, e.g., the corresponding timer expires, the BSR reporting module 102 of the UE 10 reports, to the corresponding eNB, the BSR of the LCG that the corresponding SRB belongs to.

Here, report of the periodic BSR and regular BSR may conform to the existing rules. However, for a padding BSR report, if the UE 10 is requested to transmit multiple MAC PDUs to one eNB (e.g., the macro eNB 20 or the pico eNB 30) in a TTI, it may be included in any of the MAC PDUs which do not contain a Regular/Periodic BSR.

Moreover, the UE 10 may further include a SR sending module (not shown), when a BSR trigger condition of at least one of the multiple eNBs to which the UE 10 is connected is satisfied and the corresponding eNB does not currently allocate uplink resource to the UE yet, the SR sending module transmits a scheduling request to the eNB to obtain the uplink resource for reporting the buffer status report to the eNB. That is, if there is no uplink resource currently allocated to transmit BSR, SR sending will be triggered. Likewise, there are also two sets of SR sending procedure for the two eNBs separately. Specifically, when a BSR trigger condition of the macro eNB 20 is satisfied, if there is no valid PUCCH resource configured by the macro eNB 20 for the SR within any TTI, the SR sending module initiates random access to the macro eNB 20. When a BSR trigger condition of a small cell eNB is satisfied, if there is no valid PUCCH resource configured by the small cell eNB for the SR within any TTI, the SR sending module initiates random access to the small cell eNB. Therefore, both eNBs should support PUCCH and random access.

For the case of DRB splitting, since one DRB can be transmitted by multiple eNBs, while the multiple eNBs are linked with non-ideal backhaul connection, each eNB needs an independent distributed scheduler. Therefore, its implementation is more complex and has many variations. Here, the multiple eNBs transmitting the DRB may be all or a part of the eNBs connected to the UE, and such eNBs are called transmitting eNBs, wherein each transmitting eNB may obtain the total BSR report of the DRB and determine itself the amount of data it can transmit. Further, when one of the transmitting eNB is a macro eNB, and the other transmitting eNBs are small cell eNBs belonged to the macro eNB, the macro eNB may determine, for the other transmitting eNBs, the amount of data that can be transmitted by respective the other transmitting eNBs for the RDB.

Hereinafter, some preferred embodiments will be illustrated with reference to the accompanying drawings, and the example will be taken with one DRB to be transmitted on two base stations, which two transmitting base stations are a macro eNB 20 and a pico eNB 30.

In one preferred embodiment of the present invention, with cooperative reference to FIG. 2 and FIG. 5, a first configuration sending module (not shown) of the macro eNB 20 transmits, to the UE 10, trigger configuration information about the buffer status report of the logical channel group to which the data radio bearer corresponding to the macro eNB 20 belongs, for the UE 10 to configure its BSR trigger condition corresponding to the macro eNB 20; when the BSR trigger condition of the macro eNB 20 is satisfied, the BSR reporting module 102 of the UE 10 transmits the buffer status report of the logical channel group to which the DRB belongs to the macro eNB 20 through MAC PDU. Here, based on the existing rules, the BSR may be triggered as periodic BSR, regular BSR, or padding BSR. Correspondingly, a first BSR receiving module (not shown) of the macro eNB20 receive the buffer status report transmitted from the UE 10.

Afterwards, a first transmission determining module (not shown) of the macro eNB 20 uses its flow control function to determine the amount of data transmitted respectively by itself and the pico eNB 30 for the DRB, based on respective load and channel condition of itself and the pico eNB 30 etc in accordance with the buffer status report, and then provides the BSR and the decision information corresponding to the amount of data determined to be transmitted by the pico eNB 30 to the pico eNB 30 via the X2 interface. Preferably, the decision information may be included in the BSR. Here, the decision information includes that the amount of data transmitted by the pico eNB 30 or that the ratio of the amount of data transmitted by the pico eNB 30 over the buffer data amount in the DRB determined by the macro eNB 20. Correspondingly, a fourth BSR receiving module (not shown) of the pico eNB 30 receives, from the macro eNB 20, the buffer status report forwarded by the macro eNB 20 and the decision information about the amount of data determined by the macro eNB 20 to be transmitted by the pico eNB 30 for the DRB, such that the pico eNB 30 allocates uplink resource to the UE 10.

In addition, due to there is delay from the UE sending the BSR to the macro eNB 20, in this duration, the UE is possible to be allocated resources and transmit data, therefore the macro eNB 20 may deduce the data transmission amount during this period and correspondingly reduce this part of amount of data from the buffer status report. Moreover, due to the uncertain latency of X2 interface, when the first transmission determining module of the macro eNB 20 forwards the BSR transmitted by the UE to the pico eNB 30, the BSR sending time may also be provided along to the pico eNB30, wherein the BSR sending time may be the time when the UE reports the BSR, or the time when the macro eNB 20 forwards the BSR, which may be labeled as SFN+subframe number, for example. Correspondingly, the fourth BSR receiving module of the pico eNB 30 may also receive the BSR sending time from the macro eNB 20 to deduce the amount of data that has been transmitted by the UE 10, and allocate uplink resource to the UE based thereupon.

In another preferred embodiment of the present invention, with cooperative reference to FIG. 3 and FIG. 5, the first configuration sending module of the macro eNB 20 and a third configuration sending module (not shown) of the pico eNB 30 transmit, to the UE 10, trigger configuration information about buffer status report of the logical channel group to which the data radio bearer respectively corresponding to the macro eNB 20 and the pico eNB 30 belongs, respectively, for the UE 10 to configure the BSR trigger conditions corresponding to the macro eNB 20 and the pico eNB 30, respectively; when the BSR trigger conditions of the macro eNB 20 and the pico eNB 30 are satisfied, the BSR reporting module 102 of the UE transmits the buffer status report of the logical channel group to which the DRB belongs to the macro eNB 20 and the pico eNB 30, respectively, so as to avoid untimely transmission of the X2 interface having a non-ideal backhaul link. Correspondingly, the first BSR receiving module of the macro eNB 20 and a third BSR receiving module of the pico eNB 30 receive the BSR of the DBR from the UE 10, respectively.

Afterwards, the first transmission determining module of the macro eNB 20 uses its flow control function to determine the amount of data transmitted respectively by itself and the pico eNB 30, and further provides the decision information corresponding to the amount of data to the pico eNB 30 via the X2 interface. Correspondingly, a third transmission receiving module of the pico eNB 30 receives the decision information from the macro eNB 20. Here, the decision information includes the amount of data determined by the macro eNB 20 to be transmitted by the pico eNB 30 or the ratio that the amount of data transmitted by the pico eNB 30 over the buffer data amount of the DRB, which may be used to facilitate the pico eNB 30 to avoid over resource allocation for the UE 10. Further, considering the latency of the X2 interface, the decision information may be provided, along with its sending time, to the pico eNB 30, so as to avoid over resource allocation on the pico eNB for the UE 10.

Besides, since the uplink resource allocation is completely different in two eNBs, for the same BSR report, it is possible that the macro eNB 20 has uplink resource allocation to transmit the BSR, while the pico eNB 30 has no uplink resource allocation to transmit the BSR, so it is necessary to trigger a SR procedure to request the pico eNB 30 for corresponding uplink resource. Therefore, the UE 10 needs to maintain two sets of BSR trigger and SR trigger mechanisms for the two eNBs separately.

In another preferred embodiment of the present invention, with cooperative reference to FIG. 4 and FIG. 5, the first configuration sending module of the macro eNB 20 and a second configuration sending module (not shown) of the pico eNB 30 transmit, to the UE 10, trigger configuration information about buffer status report of the logical channel group to which the data radio bearer respectively corresponding to the macro eNB 20 and the pico eNB 30 belongs, respectively, for the UE 10 to configure the BSR trigger conditions corresponding to the macro eNB 20 and the pico eNB 30, respectively; when the BSR trigger conditions of the macro eNB 20 and the pico eNB 30 are satisfied, the BSR reporting module 102 of the UE 10 transmit the buffer status report of the logical channel group to which the DRB belongs to the macro eNB 20 and the pico eNB 30, respectively. Correspondingly, the first BSR receiving module of the macro eNB 20 and a second BSR receiving module (not shown) of the pico eNB 30 receive the BSR of the DBR from the UE 10, respectively.

Afterwards, the first transmission determining module of the macro eNB 20 and a second transmission determining module (not shown) of the pico eNB 30 determine, based on their respective historical scheduling information, their respective amount of data transmission; therefore, it is unnecessary to exchange information between the macro eNB 20 and the pico eNB 30. Here, the historical scheduling information includes historical scheduling result of the macro eNB 20 or the pico eNB 30 in their respective single-connectivity and/or multi-connectivity, e.g., the last transmitted data amount autonomously determined by the pico eNB 30 in the case of dual-connectivity with DRB splitting, or the last transmitted data amount determined by the macro eNB 20 for the pico eNB 30 in the case of dual-connectivity with DRB splitting.

It should be noted that the present invention may be implemented in software or a combination of software and hardware; for example, it may be implemented by an ASIC (Application Specific Integrated Circuit), a general-purpose computer, or any other similar hardware devices.

The software program of the present invention may be executed by a processor to implement the above steps or functions. Likewise, the software program of the present invention (including relevant data structure) may be stored in a computer readable recording medium, for example, a RAM memory, a magnetic or optical driver, or a floppy disk, and other similar devices. Besides, some steps or functions of the present invention may be implemented by hardware, for example, a circuit cooperating with a processor to execute various functions or steps.

Additionally, a portion of the present invention may be applied as a computer program product, for example, a computer program instruction, which, may invoke or provide a method and/or technical solution according to the present invention through operations of the computer when executed by the computer. Further, the program instruction invoking the method of the present invention may be stored in a fixed or mobile recording medium, and/or transmitted through broadcast or data flow in other signal bearer media, and/or stored in a working memory of a computer device which operates based on the program instruction. Here, one embodiment according to the present invention comprises an apparatus comprising a memory for storing a computer program instruction and a processor for executing the program instruction, wherein when the computer program instruction is executed by the processor, the apparatus is triggered to run the methods and/or technical solutions according to a plurality of embodiments of the present invention.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims instead of the above description, and all variations intended to fall into the meaning and scope of equivalent elements of the claims should be covered within the present invention. No reference signs in the claims should be regarded as limiting of the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. An uplink scheduling information reporting apparatus supporting multi-connectivity at a UE, wherein the UE is connected to multiple eNBs, the apparatus comprising:
a configuration receiving module configured to receive trigger configuration information about buffer status report of a logical channel group that a corresponding radio bearer belongs to, and radio bearer configuration information and uplink resource configuration information respectively corresponding to each of the multiple eNBs, wherein the trigger configuration information is available for the UE to configure BSR trigger condition corresponding to each of the multiple eNBs;
a BSR report module configured to, when the BSR trigger condition of at least one of the multiple eNBs is satisfied, transmit to a corresponding eNB the buffer status report of the logical channel group that its corresponding radio bearer belongs to.

2. The apparatus according to claim 1, wherein the UE is connected to one macro eNB and a small cell eNB.

3. The apparatus according to claim 1, further comprising:
a SR sending module configured to, when the BSR trigger condition of at least one of the multiple eNBs is satisfied and the corresponding eNB does not allocate uplink resource to the UE yet, send a scheduling request to the eNB, so as to obtain uplink resource for reporting the buffer status report to the eNB.

4. The apparatus according to claim 1, wherein the radio bearer includes signaling radio bearer, which signaling radio bearer is transmitted by the multiple eNBs, the BSR reporting module is further configured to:
when the BSR trigger condition of at least one of the multiple eNBs is satisfied, determine amount of buffer data of signaling radio bearer transmitted to the corresponding eNB, and transmit the buffer status report of the logical channel group to which the signaling radio bearer belongs to the base station.

5. The apparatus according to claim 1, wherein the radio bearer includes data radio bearer, which data radio bearer is transmitted by at least two of the multiple eNBs, which at least two eNBs for transmitting become transmitting eNBs, in which one transmitting eNB is a macro eNB, and other transmitting eNB(s) is a small cell eNB, whose corresponding small cell is located within a macro cell provided by the macro eNB, the BSR reporting module is further configured to:
when the BSR trigger report of the macro eNB is satisfied, transmit the buffer status report of the logical channel group to which the data radio bearer belongs to the macro eNB, such that the macro eNB determines respective amount of data transmitted by itself and the other transmitting eNB(s), respectively, and further the buffer status report and decision information corresponding to the amount of data is provided by the macro eNB to the corresponding other transmitting eNB(s).

6. The apparatus according to claim 1, wherein the radio bearer includes data radio bearer, which data radio bearer is transmitted by at least two of the multiple eNBs, which at least two eNBs for transmitting become transmitting eNBs, in which one transmitting eNB is a macro eNB, and other transmitting eNB(s) is a small cell eNB, whose corresponding small cell is located within a macro cell provided by the macro eNB, the BSR reporting module is further configured to:
when the BSR trigger conditions of the transmitting eNB are satisfied, transmit the buffer status report of the logical channel group to which the data radio bearer belongs to each of the transmitting eNBs, such that the macro eNB determines respective amount of data transmitted by itself and the other transmitting eNB(s), and further the macro eNB provides decision information corresponding to the amount of data to corresponding other transmitting eNB(s).

7. The apparatus according to claim 1, wherein the radio bearer includes data radio bearer, which data radio bearer is transmitted by at least two of the multiple eNBs, which at least two eNBs for transmitting become transmitting eNBs, the BSR reporting apparatus is further configured to:
when trigger conditions of the transmitting eNBs are satisfied, transmit the buffer status report of the logical channel group to which the data radio bearer belongs to each of the transmitting eNBs, such that the each transmitting eNB determines its own transmitted amount of data based on its own historical scheduling information.

8. A facilitating uplink scheduling information reporting apparatus supporting multi-connectivity at a macro eNB, wherein a UE is connected to the macro eNB and multiple other eNBs, the apparatus comprising:
a first configuration sending module configured to transmit, to the UE, trigger configuration information about buffer status report of a logical channel group to which a data radio bearer corresponding to the macro eNB belongs, for the UE to configure a BSR trigger condition corresponding to the macro eNB;
a first BSR receiving module configured to receive, from the UE, the buffer status report when the BSR trigger condition is satisfied;
a first transmission determining module configured to determine amount of data transmitted by the macro eNB for the data radio bearer based on the buffer status report.

9. The apparatus according to claim 8, wherein the other eNBs are small cell eNBs, whose corresponding small cells is located within a macro cell provided by the macro eNB;
wherein the first transmission determining module is configured to:
determine amount of data transmitted by the other eNBs for the data radio bearer based on the buffer status report;
send decision information corresponding to the amount of data for transmission as determined for the other eNBs to the other eNBs.

10. The apparatus according to claim 9, wherein the first transmission determining module is further configured to:
transmit the buffer status report and sending time of the buffer status report to the other eNBs.

11. A facilitating uplink scheduling information reporting apparatus supporting multi-connectivity at a small cell eNB, wherein a UE is connected to the small cell eNB and multiple other eNBs, the apparatus comprising:
a second configuration sending module configured to transmit, to the UE, trigger configuration information about buffer status report of a logical channel group to which a data radio bearer corresponding to the small cell eNB belongs, for the UE to configure a BSR trigger condition corresponding to the small cell eNB;
a second BSR receiving module configured to receive, from the UE, the buffer status report when the BSR trigger condition is satisfied;
a second transmission determining module configured to determine amount of data transmitted by the small cell eNB for the data radio bearer based on the buffer status report and historical scheduling information of the small cell.

12. A facilitating uplink scheduling information reporting apparatus supporting multi-connectivity at a small cell eNB, wherein a UE is connected to one or more small cell eNBs and one macro eNB, the small cell corresponding to the small cell eNB is located within a macro cell provided by the macro eNB, the apparatus comprising:
a third configuration sending module configured to transmit, to the UE, trigger configuration information about buffer status report of a logical channel group to which a data radio bearer corresponding to the small cell eNB belongs, for the UE to configure a BSR trigger condition corresponding to the small cell eNB;
a third BSR receiving module configured to receive, from the UE, the buffer status report when the BSR trigger condition is satisfied;
a third transmission receiving module configured to receive, from the macro eNB, decision information about amount of data transmitted by the small cell eNB for the data radio bearer as determined by the macro eNB for the small cell eNB.

13. A facilitating uplink scheduling information reporting apparatus supporting multi-connectivity at a small cell eNB, wherein a UE is connected to one or more small cell eNBs and one macro eNB, the small cell corresponding to the small cell eNB is located within a macro cell provided by the macro eNB, the apparatus comprising:
a fourth BSR receiving module configured to receive, from the macro eNB, the buffer status report, transmitted by the UE and forwarded by the macro eNB, of the logical channel group to which a data radio bearer corresponding to the small cell eNB belongs, and decision information about the amount of data transmitted by the small cell eNB for the data radio bearer as determined by the macro eNB for the small cell eNB.

14. The apparatus according to claim 13, wherein the fourth BSR receiving module is further configured to:
receive, from the macro eNB, sending time of the buffer status report.

15. An uplink scheduling information reporting system supporting multi-connectivity, wherein the system comprises the uplink scheduling information reporting apparatus supporting multi-connectivity at a UE according to claim 1, the facilitating uplink scheduling information reporting apparatus supporting multi-connectivity at a macro eNB, and the facilitating uplink scheduling information reporting apparatus supporting multi-connectivity at a small cell eNB.
